(19) United States
(12) Patent Application Publication
(10) Pub. No.: US 2011/0246340 A1
(43) Pub. Date: Oct. 6, 2011

(54) METHOD AND SYSTEM FOR COLLABORATIVE EXECUTION OF BUSINESS PROCESSES

(75) Inventors: Shabbir M. Dahod, Andover, MA (US); Peter J. Spellman, Quincy, MA (US); Lucia Deus, Reading, MA (US)

(73) Assignee: TraceLink, Inc., Woburn, MA (US)

(21) Appl. No.: 12/753,563

(22) Filed: Apr. 2, 2010

(51) Int. Cl. G06Q 10/00; G06F 3/01

(52) U.S. Cl. 705/30; 715/753; 705/319; 705/7.13

(57) ABSTRACT

A computer-implemented method and system are provided for collaborative execution of business processes shared by entities and outsourced business partners providing products or services to the entities. A single software service is provided with common business process rules, a common business information schema, and a single directory of shared workspaces for registered users of all entities and outsourced partners on a publicly available server computer. The software service is managed by a third party. The users operate client devices communicating with the server computer over a global communications network to access the service. The service enables users to create collaboration workspaces. Each of the collaboration workspaces is identified in the single directory and accessible by a team of users associated with an entity and one or more outsourced business partners for one or more business processes shared by the entity and the one or more outsourced business partners. Each collaboration workspace provides a common operational view of the one or more shared business processes to the team of users to facilitate execution of the one or more shared business processes. The service facilitates interaction and sharing of information relating to one or more shared business processes among a team of users through each collaboration workspace. The service connects users to business processes by enabling users to identify and grant access rights to additional users to access a collaboration workspace.

### BACKGROUND

The present application relates generally to the execution of business processes and, more particularly, to a method and system for collaborative execution of business processes shared by entities and their outsourced business partners.

### BRIEF SUMMARY OF EMBODIMENTS OF THE INVENTION

In accordance with one or more embodiments, a computer-implemented method is provided for collaborative execution of business processes shared by entities and outsourced business partners providing products or services to the entities. The method includes providing a single software service with common business process rules, a common business information schema, and a single directory of shared workspaces for registered users of all entities and outsourced partners on a publicly available server computer. The software service is managed by a third party. The users operate client devices communicating with the server computer over a global communications network to access the service. Users can create collaboration workspaces hosted on the service. Each of the collaboration workspaces is identified in the single directory and accessible by a team of users associated with an entity and one or more outsourced business partners for one or more business processes shared by the entity and the one or more outsourced business partners. Each collaboration workspace provides a common operational view of the one or more shared business processes to the team of users to facilitate execution of the one or more shared business processes. The service facilitates interaction and sharing of information relating to one or more shared business processes among a team of users through each collaboration workspace. The service connects users to business processes by enabling users to identify and grant access rights to additional users to access a collaboration workspace.

In accordance with one or more embodiments, a computer-implemented system is provided for collaborative execution of business processes shared by entities and outsourced business partners providing products or services to the entities. The system includes a publicly available server computer communicating with client devices operated by registered users of all entities and outsourced partners. The server computer provides a single software service with common business process rules, a common business information schema, and a single directory of shared workspaces for the registered users of all entities and outsourced partners. The software service is managed by a third party. The service enables users to create collaboration workspaces. Each of the collaboration workspaces is identified in the single directory and accessible by a team of users associated with an entity and one or more outsourced business partners for one or more business processes shared by the entity and the one or more outsourced business partners. Each collaboration workspace provides a common operational view of the one or more shared business processes to the team of users to facilitate execution of the one or more shared business processes. The service facilitates interaction and sharing of information relating to one or more shared business processes among a team of users through each collaboration workspace. The service connects users to business processes by enabling users to identify and grant access rights to additional users to access a collaboration workspace.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram of a representative network in which methods and systems for collaborative execution of business processes in accordance with one or more embodiments can be implemented.

FIG. 2 is a screenshot of an example of a home page displayed on a user's client device in accordance with one or more embodiments.

FIG. 3 is a screenshot of an example of a workspace home page displayed on a user's client device in accordance with one or more embodiments.

### DETAILED DESCRIPTION

As discussed in greater detail below, various embodiments described herein are directed to computer-implemented methods and systems for collaborative execution of business processes across geographically dispersed entities (e.g., businesses, companies, or organizations) and their outsourced business partners (e.g., contract suppliers providing products or services to an entity). By way of example, an entity can be a business that sells products (e.g., life science company that sells pharmaceutical products), and outsourced business partners can be companies that are contracted to supply raw materials, manufacture the products, or package the products.

The system provides a single software service, which can be managed by a third party, on one or more publicly available server computers for facilitating the collaborative execution of business processes for multiple entities and their respective outsourced business partners. The software service has common business process rules, a common business information schema or architecture, and a directory of shared workspaces for registered users of all of the entities and outsourced partners. The common business process schema allows a network of users to execute many-to-many processes uniformly across their outsourced partners. Users, who can be geographically dispersed, access the service using client devices communicating with the server computer over a global communications network such as the Internet.

The service enables users to create secure collaboration workspaces accessible by a team of users associated with an entity and their outsourced partners for shared business processes. Each collaboration workspace provides a common operational view of shared business processes to the team of users to facilitate execution of the business processes. Users can build a network of relationships through collaboration workspaces. The workspaces are secure, and only the information shared by a relationship is available to users.

The collaboration workspaces facilitate interaction and sharing of information relating to shared business processes among the team of users. The information can include structured information such as structured business documents associated with a business process including purchase orders, work orders, material orders, forecast information, quality information, inventory disposition, inventory movement information, or product serialization information. The shared information can also include unstructured information such as shared discussions and document files including process instructions, reports, schematics, diagrams, and other documentation shared in support of the structured business processes.

The service connects users to business processes by enabling users to identify and grant access rights to additional users to access the collaboration workspace. Access rights to team members from across each company can be granted to a specific collaborative relationship by other users (e.g., by a user designated as the point-of-contact on either side of the relationship).

The service allows an entity to connect once to its outsourced partner network and can then operate with multiple (potentially hundreds of) partners using the collaboration workspaces.

The service can facilitate execution of various types of shared business processes including, but not limited to, production tracking, materials tracking, inventory monitoring, quality review, and production forecasting. These processes can be instrumented, allowing detailed analysis on the process execution across all partners, providing the opportunity to optimize cycle times and costs while maintaining the innovation and flexibility of outsourcing. The service can provide statistical analysis on business process performance across all similar business processes. For instance, the service can provide general statistics on percentage of time spent in each phase of production across all production tracking instances. This is an example of advantages provided by having a single, common schema across all entities and suppliers.

Through enhanced business collaboration, the service allows companies to create a predictable supply network, which provides numerous advantages including better performance, quality, and timeliness of external sourcing and supply chain operations.

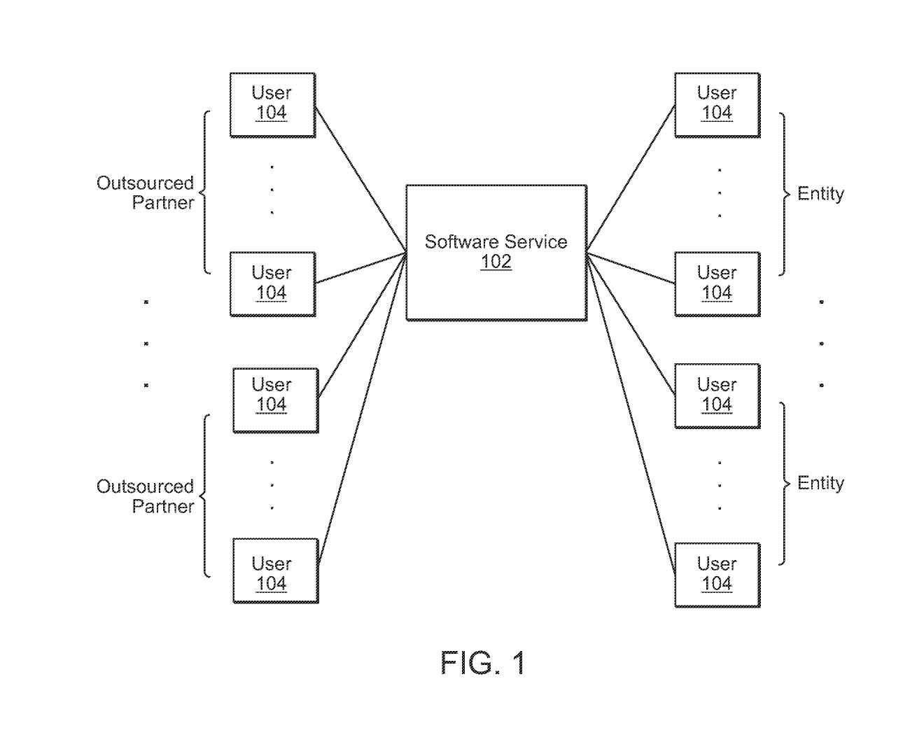

FIG. 1 is a simplified block diagram illustrating a representative network in which methods and systems for collaborative execution of business processes in accordance with one or more embodiments can be implemented. The network includes a server computer system 102, which communicates with a plurality of client devices 104 operated by system users. Each of the users is associated with one of multiple entities and outsourced partners. The client devices 104 are connected via a communications channel to the server computer system 102. The channel may, e.g., be the Internet or other network connection.

The client devices 102 may, e.g., be personal desktop or laptop computers, workstations, portable communication devices such as personal digital assistants (PDA) or smart phones, or any computing device capable of communicating with the server computer system 102. The server computer system 102 can be, e.g., a Web server, and may be implemented in a Cloud solution.

The server computer system 102 provides the software service that allows users to create the collaboration workspaces discussed above, where virtual team members from an entity and outsourced business partners interact and create a common operational view across shared business processes. The workspace connects people, processes, and information between business partners with minimal infrastructure investment.

The collaboration workspaces can be established with generally any hierarchy that suits the entity or its outsourced partners including, e.g., per product, per client, per project, per relationship, or any combination of these. As such, an entity may have a single collaboration workspace or many hundreds.

Collaboration workspaces can be created for the duration of a project (e.g., a clinical trial) then be archived until another project between the parties requires reactivation of the workspace.

A collaboration workspace can be established by a user at an entity or a user at an outsourced partner inviting the other to collaborate. The users (who can be designated as managers) can agree on the scope of the collaboration workspace, i.e., what processes and information exchanges are supported, and invite additional virtual team members to participate in the workspace.

Document sharing and messaging are built into the collaboration workspace environment and are associated and integrated to the business process context. For example, artwork specification documents may be attached to a particular purchase order. Similarly, any notes commenting on the reason for a particular activity can also be linked to the particular activity. In accordance with one or more embodiments, the workspace environment can maintain an audit trail for all changes to processes, documents, and notes.

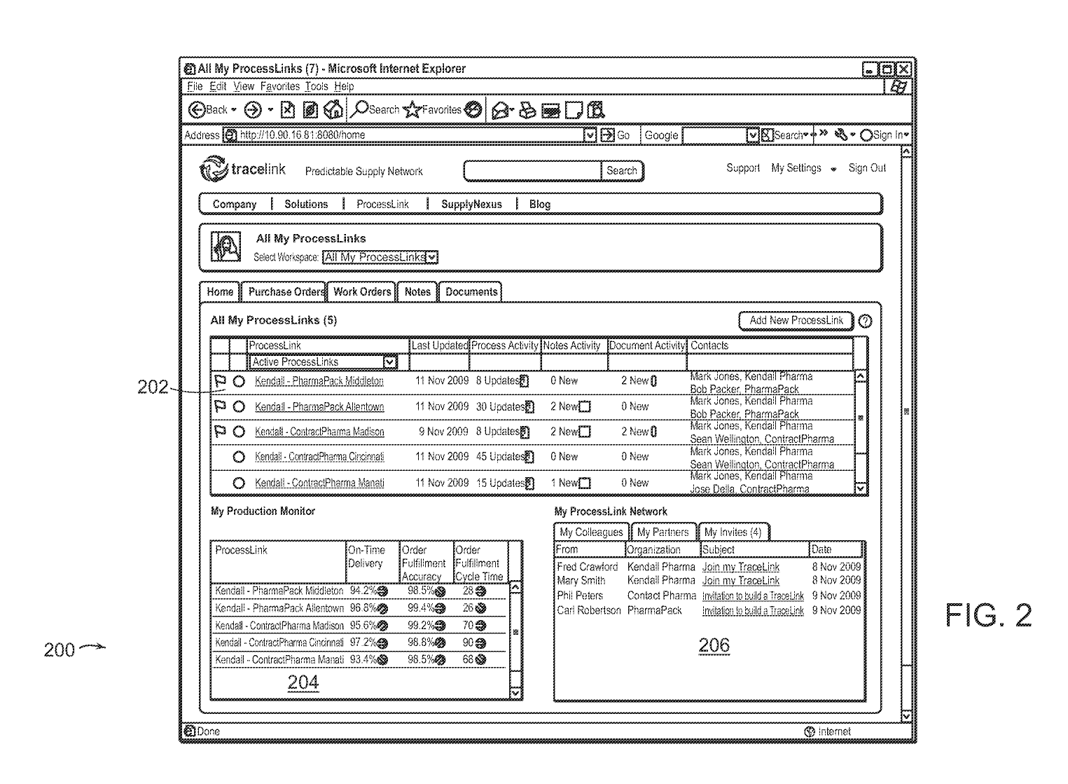

FIG. 2 is a screenshot of an example of a homepage 200 that can be displayed on a user's client device in accordance with one or more embodiments. The homepage 200 provides an aggregate view of all collaboration activity for a particular user and identifies process status, required actions, and potential risks to production schedules. In particular, the homepage provides the user with an aggregate view of business process and membership activity across all workspaces (identified in the screenshot as “ProcessLinks”) that he or she is a member of. The user can drill into a particular business process from the homepage.

The “My ProcessLinks” content block 202 provides a summary view showing information on new process activity, documents, and discussions on all workspaces that the user is a member of. The user is also provided access to business applications (e.g., Purchase Order, Work Order, etc). Each business application can provide the user with an aggregate view of all work items that span across all of the user's workspaces.

The homepage also includes a “My Production Monitor” content block 204, which allows a user to monitor performance of key business processes in each active workspace.

The homepage can also include a “My ProcessLink Network” content block 206, which gives the user the ability to view information on team members across all workspaces the user is a member of, and to respond to invitations to join new workspaces. The ability to view team members can be broken down into two parts: viewing an aggregate list of colleagues (people on the same side of each active relationship as the user), and viewing the aggregate list of partners (people on the opposite side of each active relationship as the user).

Users of the service can be assigned different roles having different privileges. For example, a user can be designated as a workspace owner (e.g., someone who created the workspace or who has been assigned ownership privileges). The owner can have all the privileges for managing the workspace (e.g., editing information, deactivating or reactivating the workspace, adding or removing participants, or assigning or replacing points of contacts). Other user roles having different privileges can include participant (a general user who was invited to participate in the workspace), a partner point of contact, a customer point of contact, and a supplier point of contact.

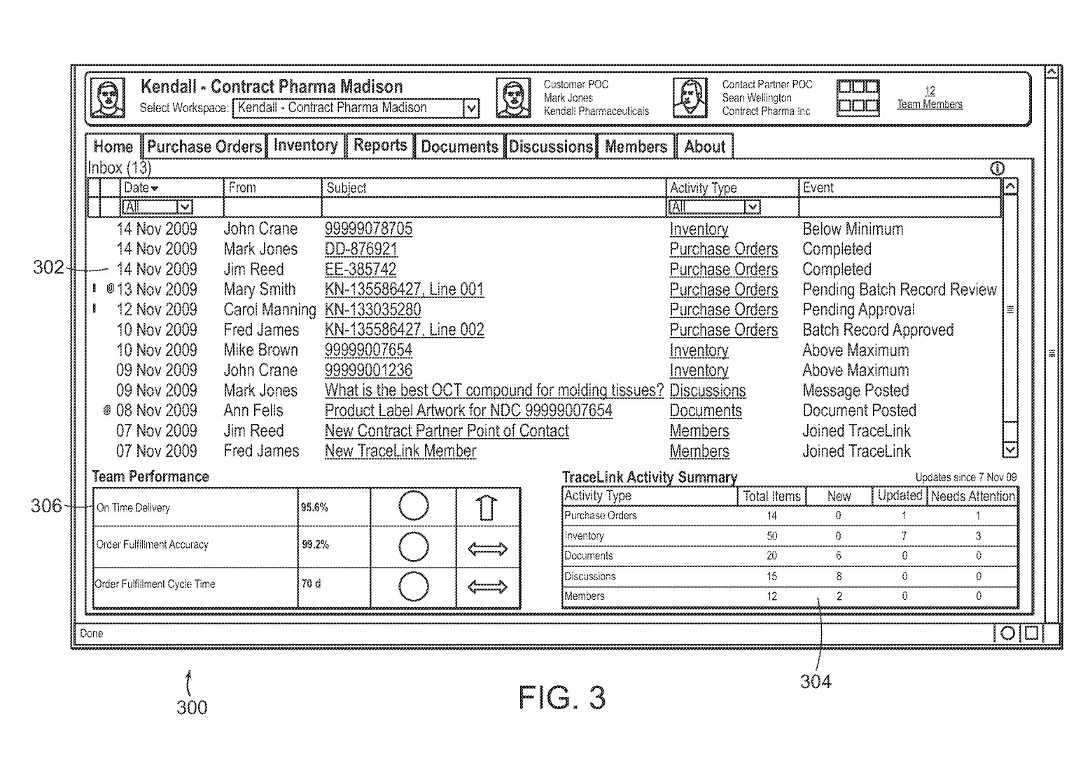

FIG. 3 is a screenshot of an example of a workspace home page 300 that can be displayed on a user device. The homepage 300 allows a user to view activity across a business process and members of the workspace. The homepage 300 includes an inbox 302, which provides a view of new events occurring within a workspace. The homepage 300 also includes an activity summary content block 304, which provides an at-a-glance view of activity occurring in the workspace. A team performance chart content block 306 is also provided, which allows the user to track performance of the team against key metrics including, e.g., on-time delivery, order fulfillment accuracy, and order fulfillment cycle time.

In accordance with one or more further embodiments, the service includes an integrated member directory, providing functionality similar to the LinkedIn business-oriented social networking site. The directory allows users to search for partners meeting particular criteria and capabilities. It also provides a simplified connectivity with partners through a participant directory. In addition, it allows users to reach smaller “long-tail” partners. It can also allow users to access and leverage shared knowledge from the community of users.

In accordance with one or more further embodiments, the service includes a single integration and administration interface allowing users to easily exchange information with business partners. The interface allows a company to upload purchase orders, work orders, inventory, forecast, and other supply chain data specific to a business relationship. An interface can also be provided through which the company can download information provided by all of their partners. The interface can be implemented using, e.g., secure and scalable REST APIs and XML data formats. These standard Internet technologies and cloud infrastructure accessing a single software service with common business process rules, a common business information schema, and a single directory of shared workspaces for registered users of all entities and outsourced partners enables massive interoperability between supply-chain partners. By establishing a common interface for the supply network, companies in an industry do not have to develop unique integrations for use with their business partners.

In accordance with one or more further embodiments, the service includes a supply analytics component that taps into instrumented shared business processes including production tracking, material tracking, inventory monitoring, and quality review to enable detailed analysis on process execution across all partners for use in optimizing cycle times and reducing costs. The supply analytics component provides entities and their outsourced partners with a consolidated view into current activities as well as insight into the historical performance of the two parties. The increased operational business intelligence can be leveraged by the virtual plant team to achieve valuable insight into the performance of both parties across the integrated processes, improve strategic visibility and decision-making, and identify opportunities for improving supply performance and operational planning.

Because the software service has common business process rules and a common business information schema, it can collect information and (after an appropriate anonymization process to preserve confidentiality) provide statistical analysis on business process performance across similar business processes of many entities and outsourced partners utilizing the service. For example, the service can provide detailed analysis on the execution of a given process such as cycle time across an entire industry, or across multiple industries. The data analysis can be limited to subsets of all entities meeting any criteria captured in the schema, e.g., companies of a particular size, in a particular geographic location, or selling a particular type of product. An entity can thereby determine its standing relative to other companies meeting specified criteria.

A comprehensive view of a company's outsourced operations can thereby be built and appropriate measures shared with outsourced partners. Ongoing visibility provides entities with information needed to manage outsourced operations on a level generally consistent with in-house operations.

The supply analytics component can provide monitoring of key performance metrics including, e.g., on-time delivery against the promise dates, order fulfillment accuracy, order fulfillment cycle time, inventory levels across the contract partner network, on-time delivery of materials, average material delay, first pass batch record approval, average batch record iterations, and average batch record cycle time.

The supply analytics component can also support scorecard performance across contract partners including percentage meeting performance service level agreements (SLAs) and performance trends among supply partners.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The server computer system 102 providing the collaboration workspace services described above may comprise one or more physical machines, or virtual machines running on one or more physical machines. In addition, the computer server system may comprise a cluster of computers or numerous distributed computers that are connected by a network or the Internet.

The collaboration workspace services described above are preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD or DVD ROM), a removable storage device (e.g., external hard drive, memory card, or flash drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

Any method claims set forth below having steps that are numbered or designated by letters should not be considered to be necessarily limited to the particular order in which the steps are recited.

What is claimed is:

1. A computer-implemented method for collaborative execution of business processes shared by entities and outsourced business partners providing products or services to the entities, the method comprising:
providing a single software service with common business process rules, a common business information schema, and a single directory of shared workspaces for registered users of all entities and outsourced partners on a publicly available server computer, said software service managed by a third party, said users operating client devices communicating with the server computer over a global communications network to access the service;
enabling users to create collaboration workspaces hosted on said service, each of the collaboration workspaces being identified in the single directory and accessible by a team of users associated with an entity and one or more outsourced business partners for one or more business processes shared by said entity and said one or more outsourced business partners, each collaboration workspace providing a common operational view of the one or more shared business processes to the team of users to facilitate execution of the one or more shared business processes;
facilitating interaction and sharing of information relating to one or more shared business processes among a team of users through each collaboration workspace; and
connecting users to business processes by enabling users to identify and grant access rights to additional users to access a collaboration workspace.

2. The method of claim 1, wherein the one or more shared business processes comprise production tracking, materials tracking, inventory monitoring, quality review, or production forecasting.

3. The method of claim 1 further comprising archiving a collaboration workspace after a given event or expiration of a given time period.

4. The method of claim 1 further comprising storing an audit trail of changes to a shared business process or the information.

5. The method of claim 1 wherein the information comprises structured information including structured business documents associated with a business process including purchase orders, work orders, material orders, forecast information, quality information, inventory disposition, inventory movement information, or product serialization information.

6. The method of claim 1 wherein the information comprises unstructured information including shared discussions and document files including process instructions, reports, schematics, diagrams, and other documentation shared in support of the structured business processes.

7. The method of claim 6 wherein the unstructured information can be associated with individual steps within a business process.

8. The method of claim 1 further comprising assigning a given role to each user, wherein users with different roles have different privileges for managing or using a collaboration workspace.

9. The method of claim 1 further comprising providing instrumentation of a business process to allow analysis of the execution of the business process.

10. The method of claim 1 further comprising providing a database of registered users and their respective professional information, and enabling users to search the database to identify other users to connect with.

11. The method of claim 1 further comprising providing a consolidated view to users of current activities and historical performance relating to a business process to improve performance and assist in planning.

12. The method of claim 1 further comprising providing a user with a global view of all business processes associated with the user.

13. The method of claim 1 further comprising of providing users with analysis of business process performance across all entities and all outsourced business partners, or across a subset of all entities and outsourced business partners meeting specified criteria.

14. A computer-implemented system for collaborative execution of business processes shared by entities and outsourced business partners providing products or services to the entities, the system comprising:
a publicly available server computer communicating with client devices operated by registered users of all entities and outsourced partners;
said server computer providing a single software service with common business process rules, a common business information schema, and a single directory of shared workspaces for the registered users of all entities and outsourced partners, said software service managed by a third party;
said service enabling users to create collaboration workspaces, each of the collaboration workspaces being identified in the single directory and accessible by a team of users associated with an entity and one or more outsourced business partners for one or more business processes shared by said entity and said one or more outsourced business partners, each collaboration workspace providing a common operational view of the one or more shared business processes to the team of users to facilitate execution of the one or more shared business processes;
said service facilitating interaction and sharing of information relating to one or more shared business processes among a team of users through each collaboration workspace; and
said service connecting users to business processes by enabling users to identify and grant access rights to additional users to access a collaboration workspace.

15. The system of claim 14 wherein the one or more shared business processes comprise production tracking, materials tracking, inventory monitoring, quality review, or production forecasting.

16. The system of claim 14 wherein the service archives a collaboration workspace after a given event or expiration of a given time period.

17. The system of claim 14 wherein the service stores an audit trail of changes to a shared business process or the information.

18. The system of claim 14 wherein the information comprises structured information including structured business documents associated with a business process including purchase orders, work orders, material orders, forecast information, quality information, inventory disposition, inventory movement information, or product serialization information.

19. The system of claim 14 wherein the information comprises unstructured information including shared discussions and document files including process instructions, reports, schematics, diagrams, and other documentation shared in support of the structured business processes.

20. The system of claim 19 wherein the unstructured information can be associated with individual steps within a business process.

21. The system of claim 14 wherein the service facilitates assigning a given role to each user, wherein users with different roles have different privileges for managing or using a collaboration workspace.

22. The system of claim 14 wherein the service provides instrumentation of a business process to allow analysis of the execution of the business process.

23. The system of claim 14 wherein the service provides a database of registered users and their respective professional information, and enables users to search the database to identify other users to connect with.

24. The system of claim 14 wherein the service provides a consolidated view to users of current activities and historical performance relating to a business process to improve performance and assist in planning.

25. The system of claim 14 wherein the service provides a user with a global view of all business processes associated with the user.

26. The system of claim 14 wherein the service provides users with analysis of business process performance across all entities and all outsourced business partners, or across a subset of all entities and outsourced business partners meeting specified criteria.
